(19) United States
(12) Patent Application Publication
(10) Pub. No.: US 2007/0170113 A1
(43) Pub. Date: Jul. 26, 2007

(54) Insitu Grease/Biosolid Bioremediation Apparatus and Method

(76) Inventors: Markus Johannes Lenger, Laguna Niguel, CA (US); Robert Edwin Carr, Odessa, MO (US)

Correspondence Address: Markus Lenger, 28101 Klamath Court, Laguna Niguel, CA, 92677, US

(21) Appl. No.: 11/625,316

(22) Filed: Jan. 20, 2007

Related U.S. Application Data
(60) Provisional application No. 60/760,458, filed on Jan. 20, 2006.

(51) Int. Cl. C02F 3/00

(52) U.S. Cl. 210/608

(57) ABSTRACT

One embodiment to assist bioremediation in grease intercepters to substantially reduce FOG (fats, oils and grease) commonly installed in Food Service Establishments. The embodiment consists of a open elongated enclosure (28) containing a media basket (22) positioned in an pneumatically accelerated flow generated by a aeration lateral (26) located towards the bottom of the device. The embodiment is inserted into existing grease interceptors and rests submerged at the bottom of the grease vault. It only requires a constant air supply via a readily available air pump. The airflow moves the liquid to the media, providing the oxygen for the biofilm around the media tubes (20). The biological processes of the biofilm results in the reduction of FOG. The effectiveness of the systems depends on the regular introduction of microbes. Alternatively the embodiment can be used in animal waste lagoons, septic systems, waste water treatment basins etc.

### CROSS-REFERENCE TO RELATED APPLICATIONS

This application claims the benefit of provisional patent application Ser. No. 60/760,458 filed Jan. 20, 2006 by the present inventors.

### FEDERALLY SPONSORED RESEARCH

Not Applicable

### SEQUENCE LISTING OR PROGRAM

Not Applicable

### BACKGROUND

1. Field of Invention

This invention relates to wastewater and solid treatment, specifically the bioremediation of Grease and Biosolids.

2. Prior Art

Food service establishments produce Fats, Oils and Grease commonly referred to as FOG. It is prohibited to discharge FOG directly into the sewer system. A grease interceptor or grease vault is commonly installed prior to discharge into the municipal sewer system. It consists of multiple chambers that trap the FOG. The food service establishments effluent is routed through this grease interceptor's feed by gravity alone. Grease interceptors then capture the FOG and other biosolids by means of gravity separation and flotation. Its function is identical to an oil/water separator. Depending on the amount of FOG/biosolids contained in the discharge, the grease interceptors fill up with solids and need to be pumped empty. This operation is usually performed several times a year. The FOG-water mixture is either disposed in a landfill, processed at a suitable wastewater treatment plant or reprocessed. It also necessitates transport of hazardous material and the excavation (pumping) procedure which is noisy, creates lingering bad odor, is a health risk and expensive. It has been established that most grease interceptors are poorly maintained and therefore are failing in their function to hold back the FOG. As a result FOG reaches the sewer system and clogs lift (pump) stations and sewer lines. These conditions are one of the main contributors to SSO's (Sanitary Sewer Overflows) resulting in huge fines for cities and water districts, beach closures and a multitude of health and environmental hazards. Since Food service establishments are odor sensitive and there is a growing environmental concern and regulation regarding safe transporting and disposing of FOG, a method of insitu (inside the grease interceptor) is desirable. It eliminates odor, pumping, transport and disposal concerns as well as the potential risk of causing a SSO. Specialized microbes have been added or metered to grease interceptors but the short retention time, high and erratic flow rates have demonstrated poor effectiveness. A reliable, cost effective way of insitu remediation has been tried many times but has not resulted in a commercial success so far. In order to retain the microbes and thus the bioremediation capacity in a grease interceptor (avoiding a flushing out of the microbes) there is a need for a microbial film support structure. This solves the problem of the short retention time.

In US Patent 2003/0008382 (2003) to Tisinger, et al. discloses that bioaugmentation can be added by a liquid metering pump drawing on a container that is replenished on a periodic basis. Gram-positive micro organism, Bacillus megaterium, can effectively and efficiently degrade fats, oils and grease (as taken from the abstract) The use of a microbial film support structure at the treatment site is not discussed.

In U.S. Pat. No. 5,840,182 (1998) to Lucido, et al. discloses that a pump is connected to a drain or trap for discharging a preselected amount of the contents of a bioreactor chamber containing water, nutrients and microorganisms. Air is supplied to the bioreactor by an air-pump. A mixer such as a stirrer or paddle can be operably installed in the bioreactor chamber (see also U.S. Pat. Nos. 6,573,085; 6,402,941; and 6,488,852) Lucido, at al. also describe, as background, the use of structures to support microbial films. The described invention differs from ours in that the aeration and agitation is performed in the bioreactor, not at the treatment site.

In U.S. Pat. No. 6,187,193 (2001) to Ozama discloses that air is replenished from the lid, drain inlet and drain exit of the grease trap, and continuously supplied into the drainage surface by sprinkling the drainage. An impeller installed in the grease trap rotates to affect the stirring and splashing to activate the aerobic microorganisms. Ozama does not describe the periodic replenishing of microbes into the trap nor the use of a biofilm. He uses a pump to agitate the liquid and relies on sprinkling for air supply. Our system uses pneumatic means to move the liquid and supply air and works below the water surface.

In U.S. Pat. No. 6,758,965 (2004) to Chen discloses bioreactors that utilize bio-carriers structures to some plastic suspended media which have rough hydrophilic surfaces to promote the adherence of microorganisms. With concentrated anoxic biomass, an efficient removal of FOG matter can be achieved. The concentration of biomass, although not fixed bed, is described and there is no discussion of how the biomass is started or how environmental conditions are maintained for good microbial growth. Also Chen requires a separate apparatus, that cannot be installed inside existing grease vaults. In U.S. Pat. No. 5,911,877 (1999) Perez, et al. discloses a binder that dissolves gradually in water and releases the bacterial cultures over a period of time. A solid cake dissolves, are continuously releases bacterial cultures into packing (col. 6, lines 16-19). This approach differs from our invention in that the binder material is pre-loaded with a microbial population that is not replenished except by the introduction of a new structure comprising the binder/microbe combination. Also no aeration is discussed.

In U.S. Pat. No. 6,335,191 (2002) to Kiplinger, et al. describe a fairly complicated system comprising a bioreactor in which microbes are cultivated to be periodically released into grease traps. There is no description of a structure at the treatment site for supporting the growth of microbes.

### SUMMARY

In accordance with one embodiment an aerated microbial film support structure is placed into the treatment chamber or grease interceptor to bioremediate the FOG and/or biosolids using injected vegetative microbes.

### DRAWINGS—FIGURES

FIG. 1 is an elevated front perspective cut away view of the apparatus

FIG. 2 is a front orthogonal view of the apparatus

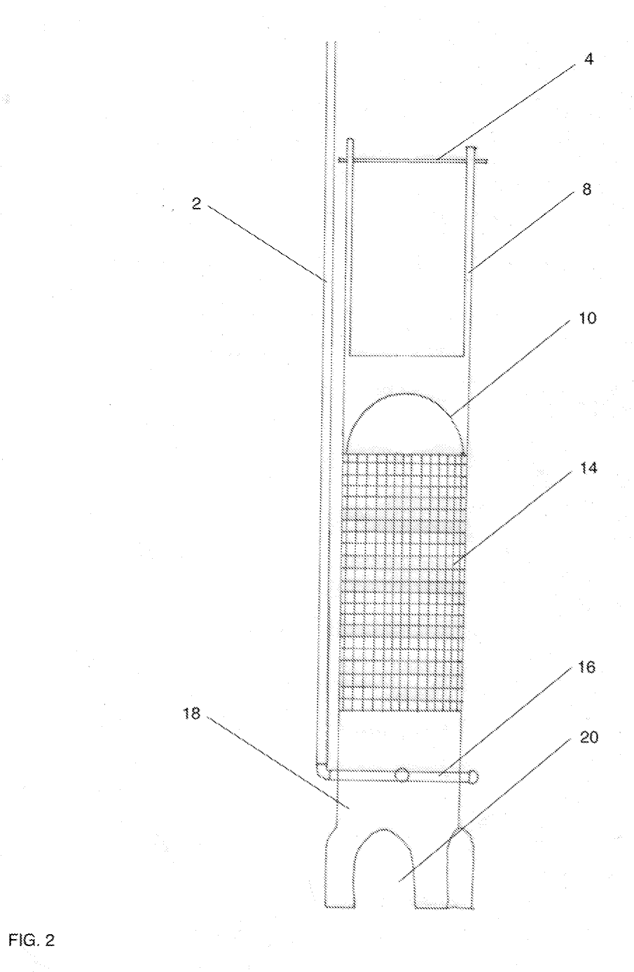

FIG. 3 is a an elevated front perspective view of the media basket containing the media

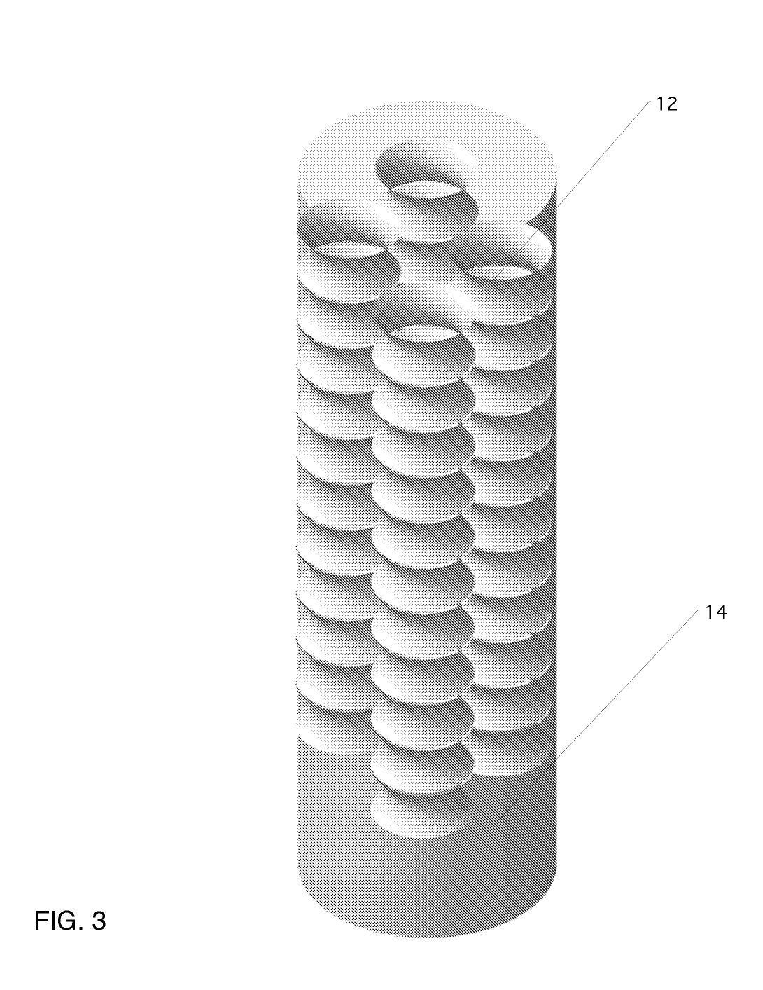

FIG. 4 is a top orthogonal view of the aeration lateral

### DRAWINGS—REFERENCE NUMERALS

10 air supply tube 22 media basket
12 handle bar/support rod 24 air vents
14 servicing rope 26 aeration lateral
16 support ears 28 elongated enclosure
18 media basket handle 30 inlet openings
20 media tubes 32 lateral end caps

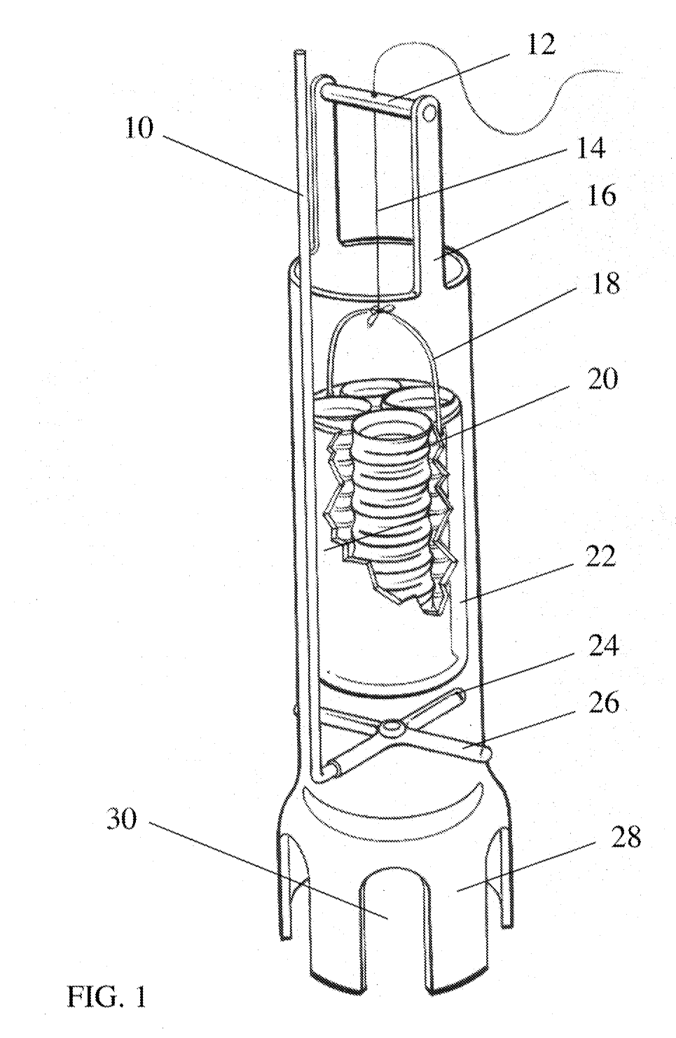

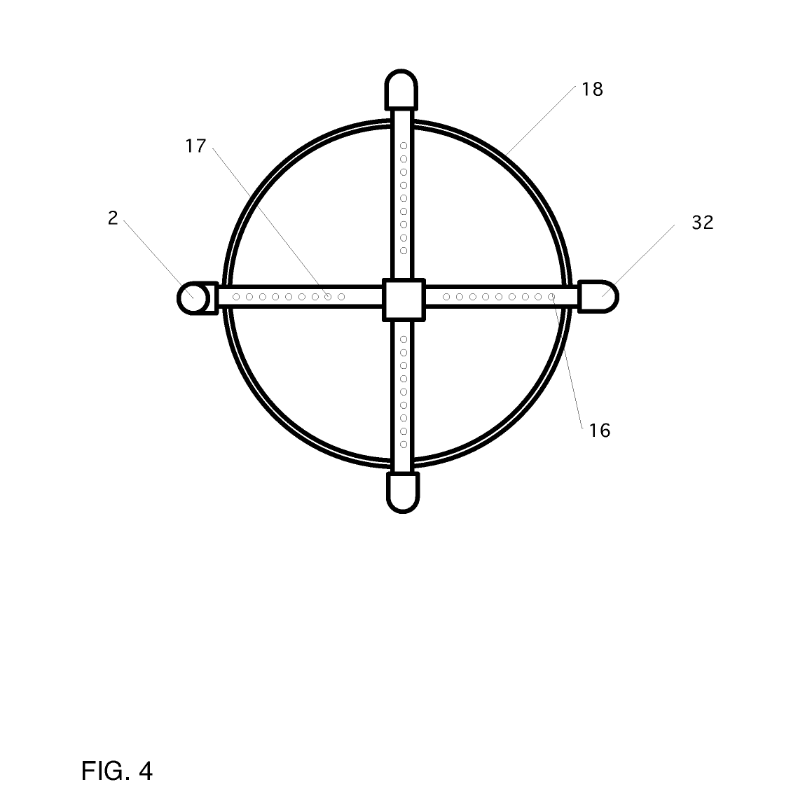

### DETAILED DESCRIPTION—FIGS 1 AND 4—ILLUSTRATED EMBODIMENT

One embodiment of the apparatus is illustrated in FIG. 1(elevated front perspective cut away view) and FIG. 4 (top orthogonal view of the aeration lateral) The apparatus is a elongated enclosure 28 containing an aeration apparatus 24, 26, a media basket 22 containing the media tubes 20. The elongated enclosure 28 is flared at the bottom to provide improved stability and prevent tilting once submerged in a grease interceptor. The height of the elongated enclosure 28 is sized to submerge deep enough in the grease interceptor allowing only support ears 16, a handle bar 12, a servicing rope 14 and the top of a air supply tube 10 to be above the water/FOG level. A readily available air pump attaches and feeds air to the top of the air supply tube 10 via a air hose (not illustrated). The air supply tube 10 runs downward along the outside of the elongated enclosure and connects to a aeration lateral 26. The aeration lateral 26 is horizontally mounted inside the elongated enclosure 28. The aeration lateral 26 is held in place by protruding through openings in the wall of the elongated enclosure. The aeration lateral 26 is secured in place by lateral end caps 32. Air vents 24 are placed along the top surface of the aeration laterals 26 allowing the supplied air to exit. Inlet openings 30 are placed at the bottom section of the elongated enclosure 28 large enough for 2 inch foreign objects to pass. A media basket 22 made from coated wire mesh or another suitable material is inserted into the elongated enclosure 28 through the opening of support ears 16. A handle bar/support rod 12 connects the top of the support ears 16. The height of the support ears 16 is sufficient to allow easy removal and reinsertion of the media basket 22 without being blocked by the handle bar/support rod 12. Attached to the media basket 22 is a media basket handle 18. A servicing rope 14 is attached to the media basket handle 18 to facilitate easy removing of the media basket 22 from elongated enclosure 28 through to opening between the support ears 16. Media tubes 20 are encased inside the media basket 22. The media tubes 20 are large diameter tubes (typically 3 to 4 inches but can be larger depending on the make up of the effluent, size of possible foreign objects and biosolids content) in the shape of stacked concentric rings of varying but repeating diameter (corrugated) with rippled interior surface.

Operations—FIGS. 1,2,3,4

The apparatus is submerged into the grease interceptor, typically one per chamber. The elongated enclosure 28 rests on the bottom of the grease interceptor. The height of the elongated enclosure 28 is dimensioned in such a way to put the water/FOG surface level just below the handle bar/support rod 12. A water/FOG level remains constant in a grease interceptor. Air delivered from an readily available air pump is fed into apparatus connected to air supply tube 10. The air exits through air vents 24 in the aeration lateral 26 embedded in the elongated enclosure 28. The air rises inside the elongated enclosure 28 through the media basket 22 passing the media tubes 20. After passing the the media basket 22 and the media tubes 20 the air exits the top of the apparatus between support ears 16, where the water/FOG surface level is located. The rising air creates a pressure differential due to what is know as the Venturi tube effect. This effect will draw the water/FOG liquid through the inlet openings 30 in the base of the elongated enclosure 28. The water/FOG liquid accelerates with the air flow and rises trough media tubes 20 inside the media basket 22. Microbes, either periodically added manually or metered in via a dosing pump, are also present in the water/FOG liquid. Alternatively natural occurring microbes present in the grease intercepter may be utilized as well. The air exiting the air vents 24 not only propels the water/FOG liquid flow but simultaneously provides the oxygen needed for the microbes to bioremediate the FOG. As a result a biofilm is formed on the surfaces of the media tubes 20 as well as the media basket 22. This biofilm is stationary and called a fixed bed biofilm as it attaches to the surfaces. The biological processes, called bioremediation of the biofilm results in the reduction of FOG. The byproducts are water, carbon dioxide and biomass. For servicing/ cleaning and inspection the media basket 22 has a handle bar/support rod 12 attached that fits through the opening created between the support ears 16 and topped by handle bar/support rod 12 to facilitate the removal and reinstallation of the media basket. The media basket 22 containing the media tubes 20 is lifted from the elongated enclosure 28 using the servicing rope 14 attached to the media basket handle 18 which is in turn attached to the media basket 22. This allows the inspection for formation of biofilm and can be serviced, replaced or cleaned. As long as the continuous or periodical source of microbes to the liquid contained in a grease vault is administered, the biofilm is maintained on the in and outside of the media tubes 20 inside the media basket 22 resulting in the reduction of FOG.

Advantages

From the descriptions above, a number of advantages of the illustrated embodiment of our Insitu grease/biosolids bioremediation apparatus become evident:

(a) The apparatus does not rely on pumps or other mechanical means to recirculate the water/FOG liquid. These methods can clog or suffer mechanical and/or electrical breakdown due to the harsh environment inside a grease interceptor. It relies solely on the rising air flow to propel the water/FOG liquid through the apparatus.

(b) The air provides not only the means of liquid motion but simultaneously supply the oxygen needed by the microbes/biofilm.

(c) No high voltage or electrical current is present inside the grease interceptor as with electrical recirculation pumps would be the case. This eliminates the danger of ignition or explosion of gases present in the grease interceptor.

(d) The apparatus will not clog due to foreign object, that may have accidentally introduced to the grease interceptor via the food service establishment.

(e) The apparatus has no moving parts, the media basket 22 and media tubes 20 are easily replaceable and easy to remove. Maintenance of the apparatus is easy.

(f) The apparatus is very economical to manufacture.

(g) The pumping/excavation interval of a grease interceptor is greatly expanded.

(h) The aerobic (oxygen rich) environment drastically reduces the formation of toxic gases like hydrogen sulfite and methane.

(i) The apparatus may be hooked up to compressed air to perform declogging if clogging occurs.

Conclusions, Ramifications, and Scope

Thus the reader will see that at least one embodiment of the insitu grease/biosolids bioremediation apparatus provides a reliable, continuous way to bioremediate FOG/biosolids at low cost. The system is easy to maintain and does not need electrical power routed into the grease interceptor.

Furthermore, the insitu grease/biosolids bioremediation apparatus has the additional advantages in that
it does not rely on pumps or other mechanical means to recirculate the water/FOG liquid. These methods can clog or suffer mechanical and/or electrical breakdown due to the harsh environment inside a grease interceptor. It uses the rising air flow to propel the water/FOG liquid through the apparatus.
it can work with a variety of different microbial cultures, ready available vegetative microbes in either liquid or solid (block or powder) form can be used in this apparatus by ways of introducing it into the waste stream either in the kitchen drains/processing floor drains or directly into the grease interceptor.
it may be hooked up to compressed air to preform declogging or increase the liquid circulation of the apparatus.
it simultaneously supplies the oxygen needed by the microbes/biofilm and provides the means of liquid motion/recirculation.
it drastically reduces the formation of toxic gases like hydrogen sulfite and methane.
it expands greatly the pumping/excavation interval of a grease interceptors.
it is very economical to manufacture
it has no moving parts, the media basket 22 and media tubes 20 are easily replaceable and easy to remove.
it is easy to maintain.
it will not clog due to foreign object, that may have accidentally introduced to the grease interceptor via the food service establishment.

While my above description contains many specificities, these should not be construed as limitations on the scope of the invention, but rather as an exemplification of on [or several] preferred embodiment thereof. Many other variations are possible. For example, changing the carrier media to bio-balls or similar structures can more effectively handle liquid waste with less solids, such as food waste in food processing plants of a wide variety. Alternatively a variety of different media can be employed to increase effectiveness on individual waste streams. This apparatus can also be used in animal waste lagoons such as hog lagoons, dairy lagoons etc. Treatment capabilities in septic tanks, waste water treatment basins etc. can drastically improve when deploying this apparatus.

Thus the scope of the embodiment should be determined by the appended claims and their legal equivalents, rather than by the example given.

We claim:

1. Means for insitu bioremediation of fats, oils, grease and biosolids comprising of:
(a) a elongated enclosure (28) containing a media basket (22) enclosing media tubes (20) is submerged in a grease interceptor,
(b) a air supply attached to aeration lateral (26) below the media basket (22) supplying the oxygen for the microbial biofilm and simultaneously recirculating the effluent or water/fats, oil, grease mixture throughout the grease chambers and the media tubes (20),
(c) means for method of stimulating biological processes of either added or naturally occur ring microbes inside the grease interceptor,

2. The recirculating the effluent or water/fats, oil, grease mixture of claim 1 further including inlet openings (30) and support ears (16) wherein it enters through the inlet openings (30) at the bottom of the elongated enclosure (28) and exits between the sup port ears (16) on top of said elongated enclosure (28),

3. The media basket (22) of claim 1 wherein being removable via further including the media basket handle (18) by means of pulling the attached servicing rope (14),

4. The media tubes (20) of claim 1 can be substituted with other suitable media such as bioballs,
whereby the embodiment will substantially reduce the grease/fats,oils,grease/biosolids content in grease interceptors.
